(19) United States
(12) Patent Application Publication
(10) Pub. No.: US 2016/0247482 A1
(43) Pub. Date: Aug. 25, 2016

(54) Programmable Gamma Correction Buffer Circuit Chip and Method for Generating Gamma Voltage

(71) Applicant: SHENZHEN CHINA STAR OPTOELECTRONICS TECHNOLOGY CO., LTD., Shenzhen, Guangdong (CN)

(72) Inventors: Dekang ZENG, Shenzhen, Guangdong (CN); Dongsheng GUO, Shenzhen, Guangdong (CN)

(73) Assignee: Shenzhen China Star Optoelectronics Technology Co. Ltd., Shenzhen, Guangdong (CN)

(21) Appl. No.: 14/379,845

(22) PCT Filed: Jun. 26, 2014
(86) PCT No.: PCT/CN2014/080830

§ 371 Date: Aug. 20, 2014

(30) Foreign Application Priority Data
Jun. 17, 2014 (CN) 201410269184.1

(51) Int. Cl. G09G 5/10

(52) U.S. Cl. CPC G09G 5/10; G09G 2320/0276; G09G 2320/0673

(57) ABSTRACT

The present invention provides a programmable gamma correction buffer circuit chip and a method for generating gamma voltage. Wherein, the circuit chip includes an operational amplifier OP, of which an inphase input terminal is coupled to a reference voltage input terminal through a first resistor R1, and an inverse-phase input terminal is coupled to an output terminal through a reference resistor Rf; the inverse-phase input terminal is coupled to ground through n second resistors Rs coupled in parallel, wherein n is an amount of step into which the reference voltage Vref is divided; the reference voltage Vref is a reference potential difference of each step, and each of the second resistors Rs is coupled to a switch S in serial. The present invention improves the structure of the programmable gamma correction buffer circuit chip such that no MOS transistor is used, and the chip size and cost is reduced.

### CROSS REFERENCE TO RELATED APPLICATIONS

This application claims priority to Chinese Application Serial No. 201410269184.1 filed on Jun. 17, 2014, named as “Programmable Gamma Correction Buffer Circuit Chip and Method for Generating Gamma Voltage”, content of which is incorporated herein by reference.

### FIELD OF THE INVENTION

The present invention relates to field of image displaying, and more particularly to a programmable gamma correction buffer circuit chip and method for generating gamma voltage.

### BACKGROUND OF THE INVENTION

In driving theory of the TFT-LCD, the data driver performs gamma 2.2 correction basing on gamma voltage. A programmable gamma correction circuit chip (P_Gamma IC) is an integrated circuit chip generating each gamma voltage after doing DAC (Digital-to-Analogue Conversion) by a digital logic circuit. The P_Gamma IC nowadays subdivides the analog reference voltage Vref into 2^{S} steps (S is DAC bits) by the digital logic circuit, then selects corresponding channel through MOS transistors in the DAC module, and finally obtains corresponding analog voltage by a voltage follower (OP) to generate gamma voltage necessity of the analog voltage. In the situation, an amount of S×2^{S} MOS transistors are needed. FIG. 1 is a 3-bit DAC module circuit, wherein there are 24 (3×8) MOS transistors can be found in the figure. For higher bits, such as 10-bit, there are 10240 (10×1024) MOS transistors are needed. The amount of the MOS transistors directly affects size and cost of the IC, and size and cost of the IC is greatly increased due to excessive MOS transistors without doubt.

### SUMMARY OF THE INVENTION

The technical problem solved by the present invention is to provide a programmable gamma correction buffer circuit chip and method for generating gamma voltage which can effectively reduce size and cost.

To solve the above mentioned technical problem, the present invention provides a programmable gamma correction buffer circuit chip, wherein includes an operational amplifier OP, of which an inphase input terminal is coupled to a reference voltage input terminal through a first resistor R1, and an inverse-phase input terminal is coupled to an output terminal through a reference resistor Rf; the inverse-phase input terminal is coupled to ground through n second resistors Rs coupled in parallel, wherein n is an amount of step into which the reference voltage Vref generated by the programmable gamma correction buffer circuit chip is divided; the reference voltage Vref is a reference potential difference of each step, and each of the second resistors Rs is coupled to a switch S in serial.

Wherein, a resistance of the second resistor Rs is the same as the resistance of the reference resistor Rf.

Wherein, the resistance of the second resistor Rs, reference resistor Rf, and the first resistor R1 is the same.

The present invention further provides a programmable gamma correction buffer circuit chip, wherein includes an operational amplifier OP, of which an inphase input terminal is coupled to a reference voltage input terminal through a first resistor R1, and an inverse-phase input terminal is coupled to an output terminal through a reference resistor Rf; the inverse-phase input terminal is coupled to ground through n second resistors Rs coupled in parallel, wherein n is an amount of step into which the reference voltage Vref generated by the programmable gamma correction buffer circuit chip is divided; the reference voltage Vref is a reference potential difference of each step, and each of the second resistors Rs is coupled to a switch S in serial; the resistance of the second resistor Rs, reference resistor Rf, and the first resistor R1 is the same.

The present invention further provides a method for generating gamma voltage, comprising:

step S1, providing a programmable gamma correction buffer circuit chip, wherein the programmable gamma correction buffer circuit chip includes an operational amplifier OP, of which an inphase input terminal is coupled to a reference voltage input terminal through a first resistor R1, and an inverse-phase input terminal is coupled to an output terminal through a reference resistor Rf; the inverse-phase input terminal is coupled to ground through n second resistors Rs coupled in parallel, wherein n is an amount of step into which the reference voltage Vref generated by the programmable gamma correction buffer circuit chip is divided; the reference voltage Vref is a reference potential difference of each step, and each of the second resistors Rs is coupled to a switch S in serial;

step S2, obtaining a value m from a register of the programmable gamma correction buffer circuit chip to control m switches S to turn on; and

step S3, calculating to obtain an output voltage Vout.

Wherein in the step S3, the output voltage Vout is calculated from the value m, a resistance of the second resistor Rs and the resistance of the reference resistor Rf.

Wherein, the value m is an integer that is greater than 1 and no more than n.

Wherein, the resistance of the second resistor Rs is the same as the resistance of the reference resistor Rf.

Wherein, the resistance of the second resistor Rs, the reference resistor Rf, and the first resistor R1 is the same.

The embodiment of the present invention replaces the DAC module by improving the structure of the programmable gamma correction buffer circuit chip to make the reference voltage generated therefrom be the potential difference of each divided step, such that no MOS transistor is used. The chip size and cost is reduced thereby.

### BRIEF DESCRIPTION OF THE DRAWINGS

In order to describe the technique solution of the embodiment of the present invention or the prior art more clearly, the drawings necessary for describing the embodiment or the prior art are briefly introduced below. Apparently, the drawings described below are some embodiments of the present invention. For those with ordinary skill in the art, other drawing can be obtained from the drawings below without creative efforts.

FIG. 1 is a circuit schematic diagram of a digital to analog convereter.

FIG. 2 is an electrical schematic diagram of a programmable gamma correction buffer circuit chip of the first embodiment of the present invention.

FIG. 3 is a flow chart of a method for generating gamma voltage of the second embodiment of the present invention.

### DETAILED DESCRIPTION OF PREFERRED EMBODIMENTS

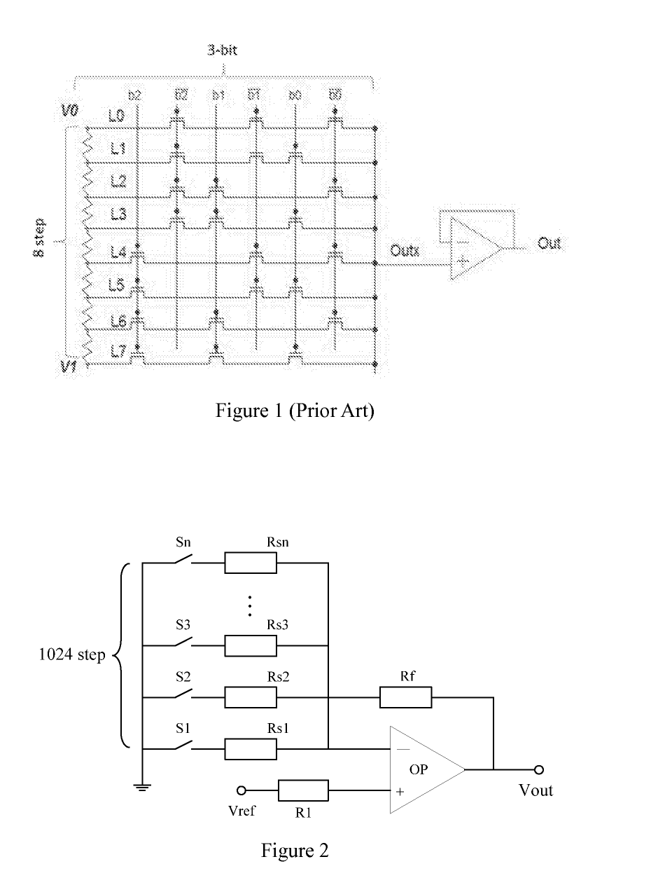

Refer to FIG. 2, the first embodiment of the present invention provides a programmable gamma correction buffer circuit chip including an operational amplifier OP, of which an inphase input terminal is coupled to a reference voltage input terminal through a first resistor R1, and an inverse-phase input terminal is coupled to an output terminal through a reference resistor Rf. The inverse-phase input terminal is coupled to ground (GND) through n second resistors Rs coupled in parallel. Wherein, n is an amount of step into which the reference voltage Vref generated by the programmable gamma correction buffer circuit chip is divided; the reference voltage Vref is a reference potential difference of each step, and each of the second resistors Rs is coupled to a switch S in serial.

Due to extremely high open loop gain of the OP, the input signals are in an extremely small range, with little difference, and approximately the same (only different in millivolt) when there is negative feedback; that is equivalent to short the inphase input terminal and the inverse-phase input terminal, but not to short them really, i.e., virtual shorting. Besides, the input resistance of the OP is great and the current flowing into the inphase input terminal and inverse-phase input terminal is too small to be ignored; that is equivalent to open the input terminals of the OP, but not to open them really, i.e., virtual opening. According to virtual shorting, the voltage of the inphase input terminal and the inverse-phase input terminal of the OP is the reference voltage Vref. According to virtual opening, current flowing through the parallel circuit consisting of the n second resistors Rs (each second resistor Rs has the same resistance) and the switches is the same as the current flowing through the reference resistor Rf. Therefore, the formulas below are established:

$$\begin{matrix}\frac{Vref}{Rs \text{/} m} = \frac{Vout}{Rf + Rs \text{/} m} & ( 1 ) \\ Vout = \frac{Vref \times Rs + m \times Vref \times Rf}{Rs} = ( 1 + m \times \frac{Rf}{Rs} ) \times Vref & ( 2 )\end{matrix}$$

Wherein, m is the value in a register of the programmable gamma correction buffer circuit chip and can be adjusted basing on requirement. The value m is an integer which is greater than 1 and no more than n.

In other words, after determining the resistance of the reference resistor Rf and the second resistor Rs, the output voltage Vout of the output terminal of the OP and the reference voltage Vref is in a linear relationship because of the formula (2). Accordingly, different output voltages can be obtained by turning on different amount of the switches, and therefore each gamma voltage needed by the liquid crystal display panel (TFT-LCD Panel) can be obtained. After obtaining the value m from the register, there are corresponding m switches turned on for reducing the value of Rs/m, and the output voltage Vout can be calculated and obtained from the formula (2).

For example, FIG. 2 shows to divide the reference voltage into 1024 steps such that the inverse-phase terminal of the operational amplifier is coupled to ground (GND) through 1024 second resistors (Rs1, Rs2, Rs3, . . . , Rsn, n=1024) coupled in parallel. Each second resistor Rs is coupled to a switch S in serial, and the amount of the switch is 1024. The value m is chosen from the range of 1˜1024. When m=2, two switches S are turned on to simulate that two second resistors Rs are coupled in parallel, and one end of the parallel coupled two second resistors Rs is coupled to the reference resistor Rf in serial while another end of the parallel coupled two second resistors Rs is coupled to ground, such that Vout=(1+Rs/Rf) Vref. For the same reason, when m=8, eight switches S are turned on to simulate that eight second resistors Rs are coupled in parallel, and one end of the parallel coupled eight second resistors Rs is coupled to the reference resistor Rf in serial while another end of the parallel coupled eight second resistors Rs is coupled to ground, such that Vout=(1+8×Rs/Rf) Vref.

It also can be seen from FIG. 2 that an inphase adder is applied actually to replace the DAC module in the prior art, and each required voltage can be output without using MOS transistors. The chip size and cost is reduced.

In a better implementation, the resistance of the second resistor Rs and the reference resistor is the same and is set to R. Accordingly, the formula (2) can be further simplified to be the formula (3) as below:

$$Vout = \frac{Vref \times R + m \times Vref \times R}{R} = ( 1 + m ) \times Vref \qquad ( 3 )$$

That is, the linear relationship between Vout and Vref is only related to m directly. Vout can be directly calculated and obtained after obtaining the value m.

More specifically, the resistance of the second resistor Rs, the reference resistor Rf and the first resistor R1 can be the same in order to implement the entire circuit more easily.

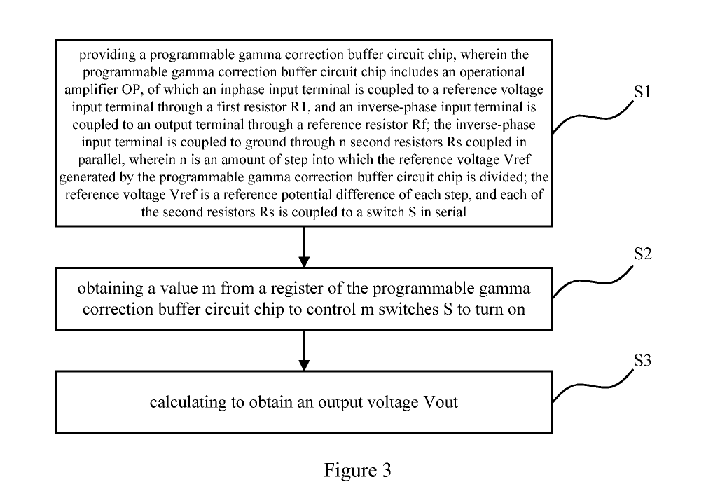

Please refer to FIG. 3, the second embodiment of the present invention provides a method for generating gamma voltage, which comprises:

step S1, providing a programmable gamma correction buffer circuit chip, wherein the programmable gamma correction buffer circuit chip includes an operational amplifier OP, of which an inphase input terminal is coupled to a reference voltage input terminal through a first resistor R1, and an inverse-phase input terminal is coupled to an output terminal through a reference resistor Rf; the inverse-phase input terminal is coupled to ground through n second resistors Rs coupled in parallel, wherein n is the amount of step into which the reference voltage Vref generated by the programmable gamma correction buffer circuit chip is divided; the reference voltage Vref is a reference potential difference of each step, and each of the second resistors Rs is coupled to a switch S in serial;

step S2, obtaining a value m from a register of the programmable gamma correction buffer circuit chip to control m switches S to turn on; and

step S3, calculating to obtain an output voltage Vout.

Specifically, in the step S3, the output voltage Vout is calculated according to the value m, the resistance of the second resistor Rs and the resistance of the reference resistor Rf. The calculating method can be referred to the formula (2) in the first embodiment of the present invention described above. As described above, m is an integer which is greater than 1 and no more than n.

In the embodiment, the resistance of the second resistor Rs is the same as the resistance of the reference resistor Rf. More specifically, the resistance of the second resistor Rs, the reference resistor Rf, and the first resistor R1 is the same.

The embodiment of the present invention replaces the DAC module by an adder by improving the structure of the programmable gamma correction buffer circuit chip to make the reference voltage generated therefrom be the potential difference of each divided step, such that no MOS transistor is used. The chip size and cost is reduced thereby. At the same time, gamma voltage generating method is improved to prevent from using devices with high cost and large size.

The above disclosure is only the better embodiment of the present invention, and therefore cannot be used to limit the scope of the present invention. The variations accordingly are still in the scope of the present invention.

What is claimed is:

1. A programmable gamma correction buffer circuit chip, wherein includes an operational amplifier OP, of which an inphase input terminal is coupled to a reference voltage input terminal through a first resistor R1, and an inverse-phase input terminal is coupled to an output terminal through a reference resistor Rf; the inverse-phase input terminal is coupled to ground through n second resistors Rs coupled in parallel, wherein n is an amount of step into which the reference voltage Vref generated by the programmable gamma correction buffer circuit chip is divided; the reference voltage Vref is a reference potential difference of each step, and each of the second resistors Rs is coupled to a switch S in serial.

2. The programmable gamma correction buffer circuit chip of claim 1, wherein a resistance of the second resistor Rs is the same as the resistance of the reference resistor Rf.

3. The programmable gamma correction buffer circuit chip of claim 2, wherein the resistance of the second resistor Rs, reference resistor Rf, and the first resistor R1 is the same.

4. A programmable gamma correction buffer circuit chip, wherein includes an operational amplifier OP, of which an inphase input terminal is coupled to a reference voltage input terminal through a first resistor R1, and an inverse-phase input terminal is coupled to an output terminal through a reference resistor Rf; the inverse-phase input terminal is coupled to ground through n second resistors Rs coupled in parallel, wherein n is an amount of step into which the reference voltage Vref generated by the programmable gamma correction buffer circuit chip is divided; the reference voltage Vref is a reference potential difference of each step, and each of the second resistors Rs is coupled to a switch S in serial; the resistance of the second resistor Rs, reference resistor Rf, and the first resistor R1 is the same.

5. A method for generating gamma voltage, comprising:
step S1, providing a programmable gamma correction buffer circuit chip, wherein the programmable gamma correction buffer circuit chip includes an operational amplifier OP, of which an inphase input terminal is coupled to a reference voltage input terminal through a first resistor R1, and an inverse-phase input terminal is coupled to an output terminal through a reference resistor Rf; the inverse-phase input terminal is coupled to ground through n second resistors Rs coupled in parallel, wherein n is an amount of step into which the reference voltage Vref generated by the programmable gamma correction buffer circuit chip is divided; the reference voltage Vref is a reference potential difference of each step, and each of the second resistors Rs is coupled to a switch S in serial;
step S2, obtaining a value m from a register of the programmable gamma correction buffer circuit chip to control m switches S to turn on; and
step S3, calculating to obtain an output voltage Vout.

6. The method of claim 5, wherein in the step S3, the output voltage Vout is calculated from the value m, a resistance of the second resistor Rs and the resistance of the reference resistor Rf.

7. The method of claim 6, wherein the value m is an integer that is greater than 1 and no more than n.

8. The method of claim 5, wherein the resistance of the second resistor Rs is the same as the resistance of the reference resistor Rf.

9. The method of claim 8, wherein the resistance of the second resistor Rs, the reference resistor Rf, and the first resistor R1 is the same.
